(19) United States
(12) Patent Application Publication
(10) Pub. No.: US 2020/0200048 A1
(43) Pub. Date: Jun. 25, 2020

(54) Rotational Power System

(71) Applicants: Kwangill Hong, Arleta, CA (US); Kenny Hong, Arleta, CA (US)

(72) Inventors: Kwangill Hong, Arleta, CA (US); Kenny Hong, Arleta, CA (US)

(21) Appl. No.: 16/229,965

(22) Filed: Dec. 21, 2018

(51) Int. Cl. F01K 15/02; B60K 3/04

(52) U.S. Cl. CPC F01K 15/02; F05D 2220/31; B60K 3/04

(57) ABSTRACT

A rotational power system (RPS) that utilizes environmental air to produce continuous rotation of a circular object such as a tire or wheel. The RPS has an air intake assembly having at least one air intake member. The intake member has an outer side edge with at least one opening into which an air intake valve is inserted, with a valve plunger extending outward from the valve. The intake member also has two side surfaces with a second side surface having an opening, and an internal cavity within which an air intake interface is located. Proximate to the air intake member is an air intake extension member having an opening, a cover with an air outlet bore, a side member with perimeter teeth, a connecting rod, and a circular structure onto which the intake assembly and the at least one intake member are attached. Connected via an air hose to the intake member is an air tank, and an air heater is connected to and receives air from the air tank. A turbine has an outer edge with concave members, an inner frame, a center opening and an axle extending through the center opening and attached to a first wheel located adjacent to the turbine. As a tire and wheel rolls on the ground surface, the tire and wheel interfaces with the extending valve plungers forcing each plunger down and causing air to enter via the air intake member and then directed through the air tank and air heater, the heated air is directed to the turbine thereby causing the turbine to rotate about the axle and the heated air to be directed back to the tire and wheel causing the tire and wheel to rotate.

### TECHNICAL FIELD

The invention generally pertains to power systems, and more particularly to a self-contained rotational power system that utilizes air to produce a constant supply of rotational power.

### BACKGROUND ART

For thousands of years mankind has attempted to harness and/or produce power, which is typically defined as the ability to supply mechanical or electrical energy. Electrical power is the rate at which electrical energy is converted to another form such as moron, heat or an electromagnetic field. Mechanical energy is typically produced by devices that are powered by human or animal effort, or that utilize the unique combination of interacting components.

One type of power that has become a necessity for modern life is rotational power. The most common application of rotational power is for motion. Rotational energy or angular kinetic energy is kinetic energy due to the rotation of an object and is part of its total kinetic energy. The mechanical work required for/applied during rotation is the torque times the rotation angle. The instantaneous power of an angularly accelerating body is the torque times the angular velocity.

There are various ways of producing rotational power, the most common being electrical energy or energy provided by an engine such as an internal combustion engine. While these methods are effective, they do have drawbacks. It is not always easy to provide the required electrical energy, and many engines must use a combustant such as gasoline or diesel fuel. Another issue is the reliability of these rotational power systems. It is common for a rotational power system to utilize many components, all of which most function correctly and constantly.

What is needed is a rotational power system that does not rely on the typical energy sources. Optimally, the energy source would be readily available and not require a large number of components to implement its use. One source that fulfills these needs is air. It has been shown that air, and especially heated air can produce a significant amount of energy. By using this air in combination with a device that can utilize the air, the possibility exists of providing an inexpensive, easily available source of rotational power.

A search of the prior art did not disclose any literature or patents that read directly on the claims of the instant inventions. However, the following U.S. patents are considered related:

| PATENT NO. | INVENTOR | ISSUED |
|---|---|---|
| 4,220,003 | Doi | Sep. 2, 1980 |
| 9,975,034 | Anderson, et al | May 22, 2018 |
| 2007/0098542 | Streeman; et al | May 3, 2017 |

The 4,220,003 patent discloses an apparatus that comprises a pair of tans, a pair of pistons, coupling means interconnecting the pair of pistons in balance, a closed chamber and a reservoir within each of the tanks and partitioned by the piston. A nozzle is disposed at one end of the closed chamber and a vale is provided on each of the pistons, rotatable means and liquid feed channels. The apparatus generates rotational power with greatly reduced energy losses.

The 9,975,034 patent discloses a device and method for a rotation powered vehicle that is capable of converting a rotational motion of a platform pivotally secured to the rotation powered vehicle in either of two angular directions into a linear motion of the rotation powered vehicle in a single linear direction for the purposes of conveyance.

The 2007/0098542 publication disclose a rotational power transfer device that includes a rotatable shaft, a plurality of arm structures attached to the shaft and extending radially outward from the shaft, a plurality of panel members attached to the arm structures and hanging downward therefrom, and an energy converting member.

For background purposes and indicative of the art to which the invention relates, reference may be made to the following remaining patents found in the patent search.

| PATENT NO. | INVENTOR | ISSUED |
|---|---|---|
| 4,169,433 | Crocker | Oct. 2, 1979 |
| 4,590,820 | Haubric | May 27, 1986 |
| 5,683,299 | Kishibuchi, et al | Nov. 4, 1997 |
| 6,010,322 | Lai | Jan. 4, 2000 |
| 6,110,061 | Kishibuchi, et al | Aug. 29, 2000 |
| 6,537,018 | Streetman | Mar. 25, 2003 |

### DISCLOSURE OF THE INVENTION

A rotational power system that includes an air intake assembly with multiple air intake members, with each intake member having an outer side edge with a plurality of threaded openings. An air intake valve has a threaded body and an opening from where extends a plunger. The threaded body on the valve is dimensioned to be screwed into one of the threaded openings on the intake member. Located on the valve body is an air bore that is positioned such that when the valve is completely screwed in to the opening, the air bore is aligned with another iar bore on the side surface of the intake member. This creates a path for air to enter the valve when the plunger is extended and then forces the air through the two aligned bores when the plunger is retracted into the valves.

Located within a cavity inside the air intake member and extending outward from the side surface of the intake member is an air interface member with a cavity and a cover over the outer extended surface. The cover has an air outlet opening and is attached onto the interface member by securing means such as bolts or screws. The dimensions of the air interface member and the air intake member allow the intake member to rotate above the interface member while the interface member remains stationary.

Extending through air intake member is a center opening that is correspondingly positioned with a center opening on the air interface member. Located proximate to the intake member and interface member is an air intake extension means that has a center opening and a side member with perimeter teeth. A connecting rod extends from the intake ember and interface member to the extension member, providing a combined rotating capability. Connected to the air intake assembly is an air tank which itself is connected to an air heater. All of the connections are facilitated by hoses and/or tubes.

Located at an optimal distance depending on the application from the air intake assembly is a turbine that preferably has an inner frame. If required the turbine can be a solid circular structure without an inner frame. Optionally, extending outward from and equidistantly positioned on an outer perimeter surface of the turbine are multiple concave members (not shown). Located at the center of the turbine is an opening through which an axle is inserted. Adjacent a distal end of the axle is an outer wheel with a center opening into which the axle extends. The outer wheel is positionally aligned with the extension member on the air intake assembly. Rotational force is produced from air initially entering the air intake assembly via the air intake valve. From the assembly the air is directed to the air tank and air heater, which provides the heated air that is directed onto the turbine. The heated air from the turbine is directed back to the outer wheel, causing the wheel to rotate.

In view of the above disclosure, the primary object of the invention is to produce a self-contained rotational power system that utilizes environmental air to produce a continuous rotational force.

In addition to the primary object it is also an object of the invention to produce a rotational power system that:
can be used to supply rotational power for a variety of purposes such as a vehicle,
is easy to use and implement,
is durable and long-lasting,
utilizes a minimal number of components,
can be retro-fitted to existing rotational power requiring devices, and
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an elevational side view of a rotational power system (RPS).

FIG. 2 is a partial cut-away view of the RPS.

FIG. 3 is a detail cut-away view of one of the RPS air intake members.

FIG. 4 is an elevational side view of a tire and wheel with the air intake member at the center and air intake valves circumventing the perimeter with valve plungers extending out from the tire and wheel.

FIG. 5 is an elevational cut-away view showing the a turbine in the form of a tire and wheel rolling over multiple air intake members below a road surface, with air intake valves positioned with plungers extending upward from the surface such that the tire rolls over each plunger, actuating the RPS to direct air back to the tire.

### BEST MODE FOR CARRYING OUT THE INVENTION

The best mode for carrying out the invention is presented in terms that disclose a preferred embodiment of a rotational power system 10 (RPS 10). There are basically the types of power in common uses today. Mechanical and electrical (other types such as nuclear or solar are not as commonly used). The mechanical or electrical power is used to generate energy, or a force. One of the most ubiquitous examples is rotational energy which is typically utilized to produce locomotion for vehicles such as cars, trucks, trains and others. While the rotational energy that is produced is effective, a major drawback is that the rotational energy must use a power source such as an internal combustion engine or electrical power.

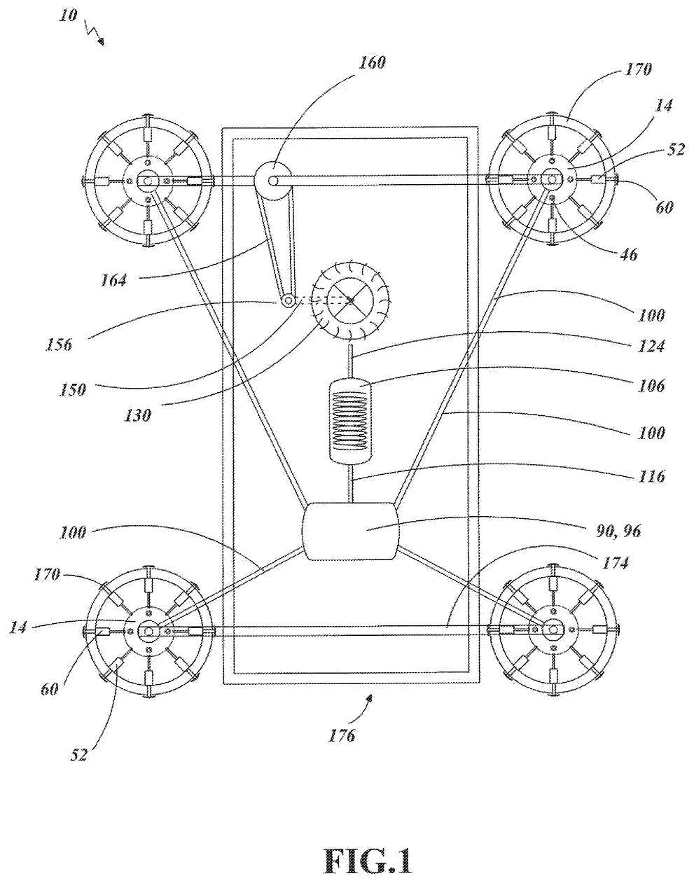

The RPS 10, provides an alternative to the conventional rotational power by utilizing common air to produce rotational power which can be used for any of the applications typically requiring this type of power. The RPS 10, as shown in FIGS. 1-5, is comprised of the following major elements: an air intake assembly 10 including an air intake member 14, an air interface member 30, and an air intake extension member 66; an air tank 90; an air heater 106; and a turbine 130. All of the major elements are preferably made of metal, although other materials could be utilized.

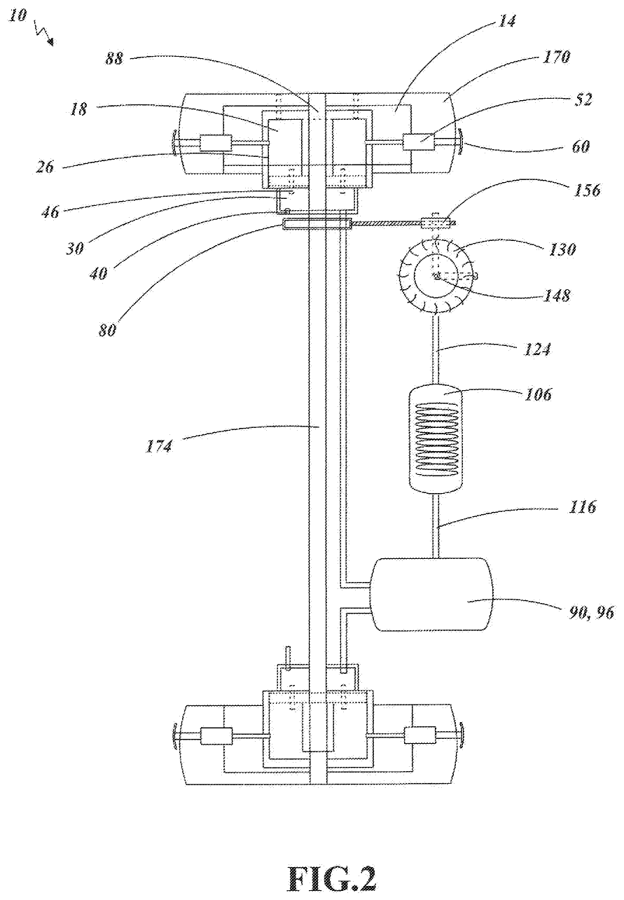

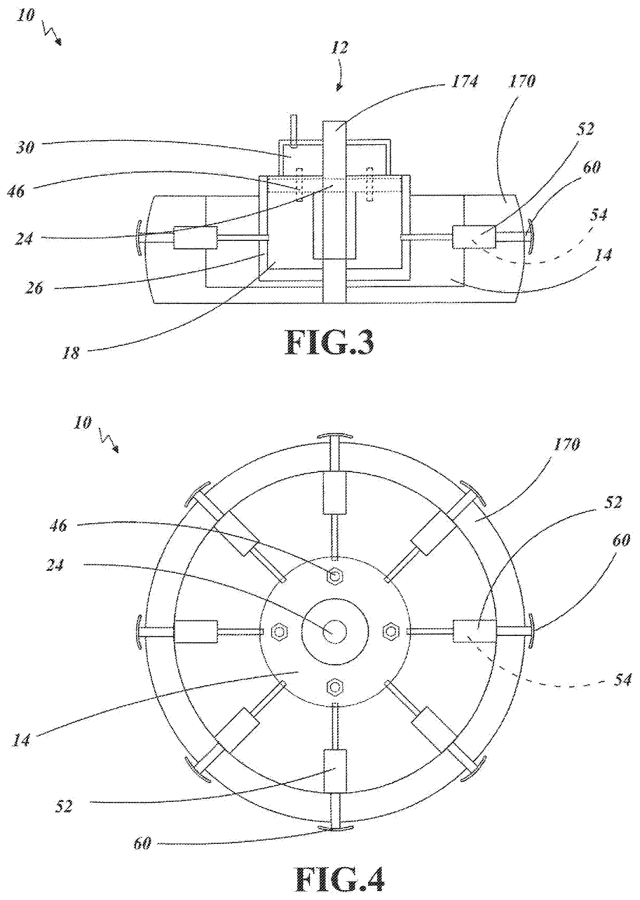

The air intake assembly 12, as shown in FIG. 3, first component is the air intake member 14, which is circular shaped. The intake member 14, as shown in FIGS. 1-4, has a first side surface 16, a second side surface 18, and an outer edge surface 120. Extending around the outer edge surface 20 are multiple equidistantly positioned threaded openings 22. Located at the substantial center, extending through the second side surface 18 is an opening 24. The air intake member has an internal cavity 26 within which is located the air interface member 30. As shown in FIGS. 2 and 3, the interface member 30 has a first side surface 34 and a second side surface 38. Attached by securing means 46 to the first side surface 34 is a cover 40 that has a center opening 48 and an air outlet bore 50. The intake member 14 and interface member 30 are dimensioned such that when the interface member is within the cavity 26, the intake member 14 can rotate about the interface member in a bearing-like action while the interface member remains stationary.

As shown in FIGS. 1-5, extending around the outer side edge 20 of the intake member 14 are multiple air intake valves 52. Each valve 52 has a threaded body 54, an upper end 56 and a valve plunger 60 that extends outward from an opening 62 on the upper end 56. The threaded body 54 of each valve corresponds to one of the threaded openings 22 on the intake member 14, thereby allowing the valve 52 to be screwed into the opening 22. In order to function, the air intake assembly 12 interfaces with a rotating structure such as a vehicle tire and wheel 170, or the air intake assembly 12 is located on a tire and wheel, with the air intake valve plungers circumventing and extending outward from the tire and wheel. Multiple air intake valves 52 can circumvent and extend outward from the perimeter of the tire and wheel 170, as shown in FIGS. 1-5. The tire and/or wheel 180 that is utilized, can be any type, such pneumatic (air-filled) tires as used on many automobiles or solid wheels that are used on a track.

Located on the valve body 54 is a side air bore 64 that allows air to exit from the valve 52. The air intake extension member 66 is circular and includes a first side surface 68 and a second side surface 70. Extending from the first side surface 68 can be an extension first side member 74, which is also circular and includes a first side surface 76 and a second side surface 78. Attached to the extension first side member first side surface is a circular first side plate 80 with teeth 84 extending around the perimeter. There are center openings 86 on the intake extension member and first side member 74. When the air intake assembly is on a tire and wheel 170, a tire axle 174, as shown in FIGS. 1-3, extends through the center openings 86 and the center openings 24,48 on the air intake member 14 and cover 14, thereby creating a rotational relationship between the air intake member 14 and the combined intake extending member 66 and first side member 74.

The air tank 90, as shown in FIGS. 1-2, has a first end 92, with air inlet opening 94, and an outer surface 96 with an air outlet opening 98. An air hose 100, as shown in FIG. 1, has a first end 102 connected to the air outlet bore 50 on the interface member cover 40, and a second end 104 connected to the air inlet opening 94 on the air tank 90.

The air heater 106, as shown in FIGS. 1 and 2, has a first end 108 with an air inlet opening 110, and a second end 112 with an air outlet opening 114. The heater is mechanically activated by the RPS 10 and heats air coming from the air tank 90.

A first heater connecting tube 116 has a first end 118 connected to the air outlet opening 98 on the air tank 90 and a second end 120 connected to the heater 106 and a second heater connecting tube 124 with a first end connected to the heater 106 and a second end 128 directed towards the turbine 130.

As shown in FIGS. 1-2, the turbine 130 typically includes a first side edge 132, a second side edge 134, an outer edge surface 136 and an inner edge surface 142. The turbine 130 can include an inner frame 144 with multiple arms radially extending from a center opening 148 to the inner edge surface 142. Extending through the center opening 148 is an axle 150 with a first end 152 and a second end 154. Located on the axle 150, adjacent the second end 154, is a first wheel 156 with a center opening 158 into which the axle 150 is inserted, as shown in FIGS. 1 and 2, connecting two tires/wheels 170 is an axle 174.

Attached to each tire/wheel is the air intake assembly 12 and a plurality of air intake members 30, with the air intake valves extending outward from an outer perimeter surface of the tire/wheel. Also attached to and rotating about the axle 174 is a second wheel 160 with a center opening 162 through which the axle 174 is inserted. The first wheel 156 and second wheel 160 are connected by a pulley cable 164, as shown in FIG. 1, that transfers rotational force via the turbine 150 to the first wheel, and onto the tire and wheel(s) 170 via the second wheel 160.

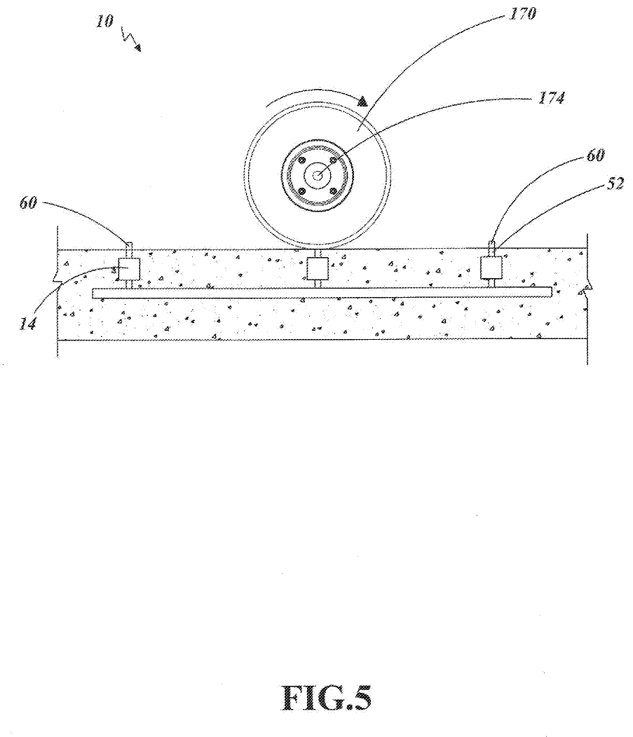

The RPS 10 can operate in two operational designs: in the first design, multiple air intake members 14 are placed below a surface such as a road 180. Each air intake member is positioned such that the air intake valve's plunger extends upward through the surface. A tire and wheel 170 rolls on/over the road surface, as shown in FIG. 5. As the tire and wheel interfaces with each plunger, the air intake member rotates and the plunger is forced inward. Air that has entered the valve via the previously open plunger is forced outward through the side air bore and enters into the air interface member within the cavity inside the intake member via the air inlet bore 38 which is aligned with the side air bore 64 when the valve is screwed into the intake member. The air then exits the interface member and travels via the air hose to the air tank. From the air tank the air travels to the air heater. Once the air is heated to the required temperature, the heated air is directed out from the heater, via the second heater connecting tube, to the turbine. The connecting hose is positioned such that the heated air directed at the turbine produces a force that causes the turbine 130 to rotate about its axis. As the air intake member continues to rotate, air is directed into the intake assembly and outward through the RPS 10. As long as a turbine rolls on the road surface, the air intake members continue to rotate. Heated air will be directed to the turbine and back to the tire and wheel, causing the tire and wheel to rotate, thereby creating an entirely self-contained rotational power system that does not utilize any outside/additional energy, other than air.

In the second operational design, multiple air intake members 14 interface with a tire and wheel 170. As shown in FIGS. 1-4, the air intake valves 52 circumvent the tire and wheel, with the plunger 60 extending outward. As the tire and wheel 170 rotates the plungers 60 contact the ground which causes the plungers 60 to retract inward, thereby forcing air into and through the valve 52. From the valve 52 the air is directed through the RPS 10 the same as the first operation manner

For both designs, the RPS 10 can be attached to a frame 176, as shown in FIG. 1, that maintains the components of the RPS 10.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A rotational power system comprising:
an intake assembly having:
at least one air intake member with:
an outer side edge having:
at least one opening into which an air intake valve is inserted with a valve plunger extending outward,
a first side surface,
a second side surface having a center opening,
an internal cavity within which an air interface member is located,
a center opening,
an air intake extension member located proximate to the air intake member and having:
a center opening,
a cover having an air outlet bore,
a side member with perimeter teeth,
a connecting rod that extends into the center opening on the air intake member and the center opening on the extension member, thereby producing a dual rotating action of the two members,
a circular structure onto which the air intake assembly and the at least one air intake member is attached,
an air tank that is connected via an air hose to the air intake member,
an air heater that is connected to and received air from the air tank via a first connecting tube,
a turbine having:
an outer edge surface with multiple concave members extending therefrom,
an inner frame,
a center opening,
an axle extending through the center opening and attached to a first wheel located adjacent the turbine,
as a tire and wheel rolls on the ground surface, the tire and wheel interfaces with the extending valve plungers forcing each plunger down and causing air to enter via the air intake member and then directed through the air tank and air heater, the heated air is directed to the turbine thereby causing the turbine to rotate about the axle and the heated air to be directed back to the tire and wheel causing the tire and wheel to rotate.

2. The rotating power system of claim 1 wherein the air intake member is made of metal.

3. The rotating power system of claim 1 wherein the air intake valve is inserted into and maintained within the opening on the air intake member by corresponding threads on a first end of the valve and within the opening.

4. The rotating power system of claim 1 wherein the air intake valve includes a plunger extending outward from an opening, and a side air opening that facilitates the inlet of air into the valve when the plunger extends.

5. The rotating power system of claim 1 wherein the turbine is comprised of a solid disk.

6. The rotating power system of claim 1 wherein the air tank is made of metal.

7. The rotating power system of claim 1 wherein the air tank is made of plastic.

8. The rotating power system of claim 1 wherein the air hose is made of a flexible material.

9. The rotating power system of claim 1 further comprising a support structure including a first horizontal member, a second horizontal member, a first vertical member, a second vertical member, wherein the air intake member, air tank, air heater, turbine, center wheel and outer wheel are secured to the support structure and maintained thereon.

10. A rotating power system comprising:
an air intake assembly with:
at least one air intake member having:
a first side surface,
a second side surface having a center opening,
an outer edge surface having at least one threaded opening,
an internal cavity,
an internal air intake member that is dimensioned to fit within the internal cavity and including:
a first side surface,
a first side surface cover having an air outlet bore,
a second side surface,
a first side surface cover having a center opening that is correspondingly positioned with the first center opening and second center opening,
a plurality of air intake valves, each valve having:
a threaded body that is dimensioned to interface with the threaded opening on the air intake member,
a threaded body that is dimensioned to interface with the threaded opening on the air intake member,
a valve plunger that extends outward from an opening,
a side air bore that facilitates the inlet of air into the valve when the plunger extends, the side air bore oriented such that when the air valve is within the threaded opening on the air intake member, the first side surface outlet bore and side air bore are aligned,
an air intake extension member having:
a first side surface,
a second side surface,
a first side plate with a perimeter teeth,
a center opening,
a connecting rod that extends into the center opening on the air intake member and the center opening on the extension member, thereby producing a dual rotating action of the two members,
an air tank having:
a first end having at least one air inlet opening,
a second end having at least one air inlet opening,
an outer surface having an air outlet opening,
an air hose including:
a first end that is connected to the air outlet bore on the cover of the air interface member,
a second end that is connected to one of the air inlet openings on the air tank,
a second end having an air outlet opening,
a first heater connecting tube with:
a first end that is connected to the air outlet opening on the air tank,
a second end that is connected to the air inlet opening on the first end of the air heater,
a second heater connecting tube with:
a first end that is connected to the air outlet opening on the air heater,
a second end,
a turbine with:
a first side edge,
a second side edge,
an outer edge surface including multiple concave members extending outward from and equidistantly located around the outer edge surface,
an inner edge surface,
an inner frame,
a center opening,
an axle with:
a first end,
a second end, and
an outer wheel with a center opening, as air enters via the air intake member and is directed through the air intake valves to the air tank and air heater, the heated air is directed onto the turbine, thereby causing the turbine to rotate about the axle and heated air to be directed back to the outer wheel, causing the wheel to rotate,

11. The rotating power system of claim 10 wherein the air intake member is made of metal.

12. The rotating power system of claim 10 wherein the turbine is comprised of a solid disk.

13. The rotating power system of claim 10 wherein the air tank is made of metal.

14. The rotating power system of claim 10 wherein the air tank is made of plastic.

15. A rotating power system comprising:
an air intake assembly with:
four air intake members with each member having:
a first side surface,
a second side surface having a center opening,
an outer edge surface having a plurality of threaded openings that circumvent the outer edge surface,
an internal cavity,
an internal air intake member that is dimensioned to fit within the internal cavity and including:
a first side surface,
a second side surface,
a first side surface cover having a center opening and,
an air outlet bore,
a plurality of air intake valves, each valve having:
a threaded body that is dimensioned to interface with the threaded opening on the air intake member,
an air outlet bore,
a plurality of air intake valves, each valve having:
a threaded body that is dimensioned to interface with the threaded opening on the air intake member,
a valve plunger that extends outward from an opening,
a side air bore that facilitates the inlet of air into the valve when the plunger extends the side air bore oriented such that when the air valve is within the threaded opening on the air intake member, the first side surface outlet bore and side air bore are aligned,
an air intake extension member having:
a first side surface,
a first side surface cover having an air outlet bore,
a second side surface,
a first side plate with a perimeter teeth,
a center opening,
a connecting rod that extends into the center opening on the air intake member and the center opening on the extension member, thereby producing a dual rotating action of the two members,
an air tank having:
a first end having at least one air inlet opening,
a second end having at least one air inlet opening,
an outer surface having an air outlet opening,
an air hose including:
an air heater including:
a first end having an air inlet opening,
a second end having an air outlet opening,
a first heater connecting tube with:
a first end that is connected to the air outlet opening on the air tank,
a second end that is connected to the air inlet opening on the first end of the air heater,
a second heater connecting tube with:
a first end that is connected to the air outlet opening on the air heater,
a second end,
a turbine with:
a first side edge,
a second side edge,
an outer edge surface including multiple concave members extending outward from and equidistantly located around the outer edge surface,
an inner edge surface,
an inner frame,
a center opening,
an axle with:
a first end,
a second end, and
an outer wheel with a center opening, as air enters via the air intake member and is directed through the air intake valves to the air tank and air heater, the heated air is directed onto the turbine, thereby causing the turbine to rotate about the axle and heated air to be directed back to the outer wheel, causing the outer wheel to rotate.

16. The rotating power system of claim 15 wherein the air intake member is made of metal.

17. The rotating power system of claim 15 wherein the turbine is comprised of a tire and wheel.
